(19) United States
(12) Patent Application Publication
(10) Pub. No.: US 2008/0017457 A1
(43) Pub. Date: Jan. 24, 2008

(54) MOUNTING SLIDE INSERT FOR USE IN A GUIDE SHOE OF AN ELEVATOR INSTALLATION, METHOD FOR PLACING AN ELEVATOR INSTALLATION INTO OPERATION, AND CORRESPONDING MOUNTING SET AND AN ASSOCIATED ELEVATOR INSTALLATION

(76) Inventors: Ernst Ach, Ebikon (CH); Peter Mori, Rothenburg (CH)

Correspondence Address: FRASER CLEMENS MARTIN & MILLER LLC, 28366 KENSINGTON LANE, PERRYSBURG, OH, 43551, US

(21) Appl. No.: 11/780,061

(22) Filed: Jul. 19, 2007

(30) Foreign Application Priority Data
Jul. 19, 2006 (EP) 06117510.5

(51) Int. Cl. B66B 7/04; B23P 19/00

(52) U.S. Cl. 187/409; 29/700

(57) ABSTRACT

A mounting slide insert for use in a guide shoe at an elevator car of an elevator installation has a slide zone and fastening regions for inserting the mounting slide insert into the guide shoe and fastening it there. The mounting slide insert is for temporary use and has two mounting slide zones, which extend substantially parallel to one another and which consist of metal material so that during movement of the elevator car along a guide rail of the elevator installation a cleaning action results at the guide rail.

### FIELD OF THE INVENTION

The present invention relates to a mounting slide insert for use in a guide shoe of an elevator installation, a method for placing an elevator installation into operation, a mounting set for use in the mounting, and an elevator installation with a mounting slide insert.

### BACKGROUND OF THE INVENTION

Use is made, for guidance of the elevator car in elevators with guide rails, of guide shoes which are arranged at the elevator car and which are designed as roller guide shoes or as sliding guide shoes. In the first case rollers are usually provided with so-termed two-dimensional or three-dimensional guiding and roll on corresponding guide surfaces of the guide rail. In the second case the sliding guide shoes are equipped with slide inserts which slide with small play along the guide rails so that they impart to the elevator car a guidance in the horizontal plane during the vertical conveying movement.

In the following there is discussion primarily of elevator installations with guide rails and corresponding sliding guide shoes for horizontal guidance of the elevator car along the substantially vertical guide rails.

In order to ensure smooth running of the elevator car which is as jolt-free as possible in elevator installations of that kind use is made, as slide inserts, of materials which are typically softer than the material of the guide rails. In addition, in the selection of the materials it is taken into consideration that during the operation of the elevator installation the smallest guide rail wear should occur.

Materials such as polyurethane or polyethylene are therefore preferably used at present in the slide inserts. There are forms of embodiment in which the plastics material slide inserts are exchangeable, since slide inserts of that kind are subject to wear. A corresponding example is evident from German Utility Model DE 203 15 915 U1.

Elevator installations are nowadays frequently installed in a building during the raw construction phase and already placed into operation during the internal building work. However, it can now happen in these cases after the later, official placing into operation of the corresponding elevator installation or after the building inspection that disturbing noises and vibrations occur in operation of the elevator installation, which gives unsatisfactory running behavior. Investigations have shown that these disturbances can be produced on the one hand by contaminations of the guide rails and/or the slide inserts and on the other hand by damage of the slide surfaces of the guide rails and/or the slide inserts as well as by inaccuracies in mounting.

The following factors, amongst others, can have an influence on the noise and vibration behavior of newly installed elevator installations:
Inadequate quality of the slide surfaces of the guide rails (for example, scale structuring);
Damage of the slide surfaces of the guide rails due to improper transport or careless mounting;

Deposit of finely grained building dust, mortar residues or the like on the slide surfaces. These factors are particularly problematic to the extent that—due to these deposits—furrows can form at the slide surface or damage of the slide inserts can occur during the sliding along of the guide shoe. In addition, mortar residues or also metal swarf, which can arise during assembly of the elevator installation, can be pressed into the slide surface of the slide insert;
Remnants of protective coatings, protective paints or grease or oil residues on the slide surfaces of the guide rails.

These factors not only have a negative influence on the running behavior at the time of placing in operation, but they can damage or influence the entire slide system in such a manner that the running behavior is permanently disturbed.

### SUMMARY OF THE INVENTION

It is therefore an object of the subsequently described invention to avoid the mentioned disadvantages of the state of the art and to create an improved solution.

In particular, it is regarded as an object of the present invention to improve the running behavior of newly installed elevator installations or of elevator installations, which within the scope of a complete revision has been exposed to dirt or suffered damage to the slide system, after the conclusion of the work or before handover of the elevator installation to a customer.

According to the present invention this object is fulfilled by:
a mounting set for mounting a sliding guide device;
a mounting slide insert for use in a guide shoe at an elevator car of an elevator installation;
an elevator installation with a mounting slide insert of that kind; and
a method for placing the elevator installation, with an elevator car and sliding guide devices, into operation.

The present invention is accompanied by the advantage that after conclusion of the work causing contamination or the work which could lead to damage of the slide system exchange can be carried out, by a few actions, of the sensitive parts of the slide system, namely the slide inserts. It is thereby possible to guarantee the desired running smoothness at the outset with the official placing in operation or the final inspection of the installation.

Further details, features and advantages of the invention are evident not only from the dependent claims and the features—by themselves and/or in combination—inferable therefrom, but also from the following description of preferred examples of embodiment.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic plan view of an elevator car with laterally mounted guide shoes and guide rails, along which the elevator car is guided;

FIG. 2A is a schematic exploded perspective view of a guide shoe with a standard slide insert;

FIG. 2B is a schematic perspective view of a mounting slide insert according to the present invention for the guide shoe in accordance with FIG. 2A;

FIG. 3A is a schematic detail plan view of a further mounting slide insert according to the present invention;

FIG. 3B is a schematic side view of the mounting slide insert according to the present invention in accordance with FIG. 3A;

FIG. 3C is a schematic sectional view of the mounting slide insert according to the present invention in accordance with FIG. 3A;

FIG. 4A is a schematic exploded perspective view of another guide shoe with a standard slide insert;

FIG. 4B is a schematic perspective view of another mounting slide insert according to the present invention for the guide shoe in accordance with FIG. 4A;

FIG. 5A is a schematic detail plan view of the other mounting slide insert according to the present invention in accordance with FIG. 4B;

FIG. 5B is a schematic side view of the mounting slide insert according to the present invention in accordance with FIG. 5A; and

FIG. 5C is a schematic sectional view of the mounting slide insert according to the present invention in accordance with FIG. 5A.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Equivalent parts are in this connection provided in the figures with the same reference numerals.

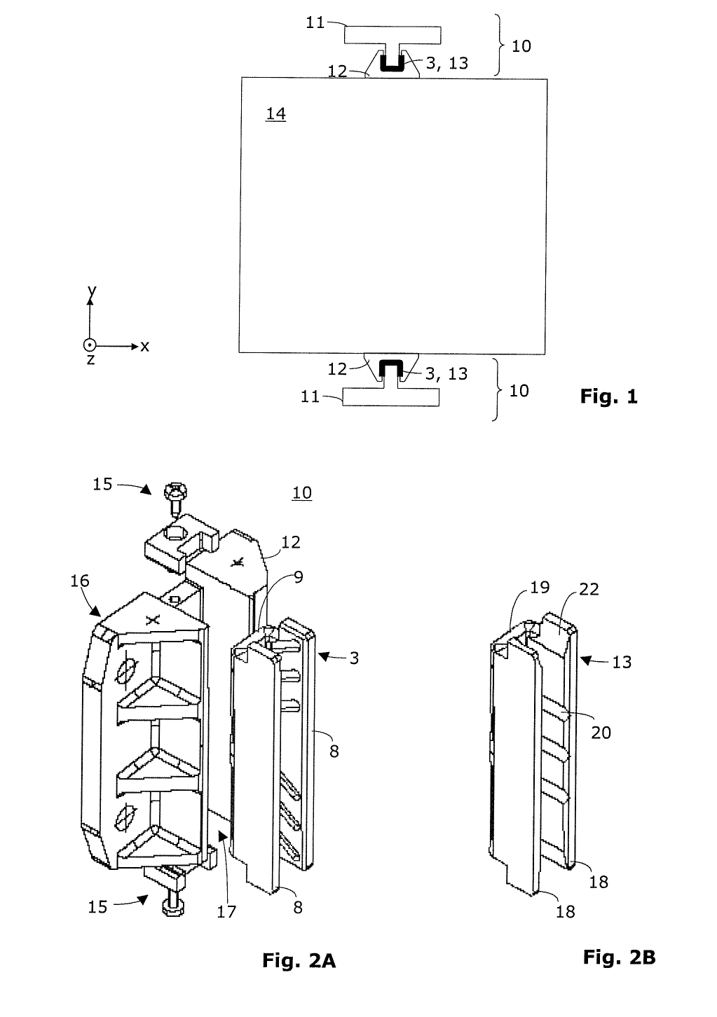

FIG. 1 shows a schematic plan view, which is not to scale, of part of an elevator installation with an elevator car 14, which is guided vertically between two laterally arranged guide rails 11 in an elevator shaft (not shown). In order to ensure the vertical guidance, as a rule four (or more) sliding guide devices 10 are fastened to the elevator car 14, which devices have a guide shoe 12 with a U-shaped receiving region for slide inserts 3, 13. A respective two of the sliding guide devices 10 are arranged in a lower region of the elevator car 14 and two further are arranged in an upper region of the elevator car 14. In FIG. 1 the slide inserts 3, 13 are indicated by U-shaped thick black lines. The guide rails 11 typically have a T-shaped cross-section and the slide inserts 3, 13 so engage around ‘trunk’ of the T-shaped guide rails 11 that two mutually opposite surfaces and a base-side surface of the slide inserts 3, 13 slide along the outwardly directed side surfaces as well as an outer end surface of the ‘trunk’ of the T-shaped guide rails 11. The two mutually opposite surfaces as well as the base-side surface of the slide inserts 3, 13 have so-termed slide zones. The term “slide zone” is used for those regions of the slide inserts 3, 13 which interact with the guide rail 11 (in sliding or wiping manner).

Before details of different forms of embodiment are discussed, the principle of the present invention is explained. According to the present invention, during the building phase, i.e. during the phase where contaminations of and/or damage to the sliding guide device 10 can happen, the special mounting slide inserts 13 are used. These mounting slide inserts 13 are, prior to the handover or building inspection, replaced by the actual slide inserts 3 which are specially designed for long-term use and the material or materials of which are designed for reduction in running noise and vibrations. The features of the special mounting slide inserts 13, thereagainst, are so selected that the cleaning function as well as a precise guidance of the elevator car have priority over the travel characteristics (noise and vibration).

The term “mounting slide insert 13” is used in the following in order to create a clear difference in language in relation to conventional slide inserts which here are also termed “standard slide inserts 3”. The selection of these special terms is not to be understood as limiting.

Details of a first form of embodiment of the present invention are shown in FIGS. 2A and 2B. FIG. 2A is an exploded view of the sliding guide device 10. The sliding guide device 10 comprises the guide shoe 12, the housing or body of which is so shaped that it has an elongate U-shaped recess or longitudinal groove 17. This longitudinal groove 17 is so constructed in accordance with the present invention that the standard slide insert 3 or alternatively, according to the present invention, the mounting slide insert 13 can be used.

The guide shoe 12 is seated by its rear side 16 at the elevator car 14 or is otherwise mechanically connected with the elevator car 14. In assembly of the elevator installation typically, according to a state of the art, the standard slide insert 3 is firstly inserted into the guide shoe 12 and only then are these so mounted as a unit on both sides of the elevator car 14 that the “trunk” of the guide rails 11 is disposed between the slide zones of the standard slide inserts 3.

According to the present invention, however, the slide shoes 12 are so designed that during the constructional work or operations to place in working order, the mounting slide sets 13 are used temporarily, i.e. in the time period prior to final placing of the elevator installation in operation or in connection with conclusion of a construction or revision phase. An example of such a mounting slide insert 13 is shown in FIG. 2B. It can be plugged or inserted into the guide shoe 12 instead of the standard slide insert 3 and fastened or fixed there. For the fastening, use is made, in the illustrated form of embodiment, of small end plates 15 which are fastened at the lower and upper end of the guide shoe 12 by means of screws as can be seen in FIG. 2A and as is known from the fastening of standard slide inserts 3.

After the work generating dirt and dust or the work which can lead to damage of the sliding guide device 10 has been concluded the fastening means 15 are now loosened and the mounting slide inserts 13 removed. The standard slide inserts 3 are then mounted.

In the form of embodiment shown in FIGS. 2A and 2B this demounting and mounting takes place without the guide shoes 12 having to be demounted or otherwise removed from the elevator car 14. The slide inserts 13 or 3 which, depending on the respective situation, have to be mounted can be pushed along the guide rail 11 from above or below into the longitudinal groove 17 and firmly screw-connected or clamped there by the fastening means 15.

In this connection it is particularly advantageous that with use of the mounting slide insert 13 the elevator car, such as, for example, door coupling parts, and shaft installation, such as, for example, position pick-ups, can be accurately mounted and lined. The mounting slide insert 13 is particularly suitable for this purpose, since it has little play and is less elastic. A standard slide insert 3, such as is usually used, is, thereagainst, elastic, since it shall absorb travel inaccuracies as free of jolt as possible.

Moreover, it is now important that the material of the mounting slide zone of the mounting slide insert 13 is so selected that during the movement of the elevator car 14 along the guide rail 11 a cleaning action at the guide 11 results. In addition, the mounting slide zone of the mounting slide insert 13 can have structural surface features so that the cleaning action is amplified or improved. In FIG. 2B a form of embodiment is shown in which several horizontal bores or horizontal milled recesses 20 are provided in the region of the mounting slide zones. Additionally or alternatively it can be ensured through the formation of chamfers 22 (as deflectors or stripper edges) in the entry and/or exit region that residues and foreign bodies on the guide rails 11 are scraped off or detached. In FIG. 2B such a chamfer 22 is visible at the top right. In an advantageous enhancement the guide shoe is equipped, during work for placing in operation, with an additional dirt deflector (not illustrated in the figures) which prevents penetration of larger objects into the guide slot. Larger objects of that kind can be screws, nuts or studs which drop down in the shaft during mounting operations or can be coarse stone fragments which, for example, break out of masonry during drilling operations.

The structural surface features primarily serve the purpose of cleaning the slide surfaces of the guide rails 11 of dirt particles and of providing compensation for damage of the slide surfaces. Thus, the structural surface features can grind off unsmooth transitions, material bulges, scales such as can result during production of guide rails, burrs or furrows or reduce the influence thereof.

The mounting slide inserts 13 are preferably so constructed that they can be used several times. They can be used again in other buildings, they can be used for providing new mounting sets or they can be left for future work on the elevator installation. Multiple use is economic.

As described in the introduction, the conventional slide inserts, i.e. the standard slide inserts 3, typically consist of plastics material. For the mounting slide inserts 13, use is made of metal, preferably cast metal, at least for the mounting slide zones. Stated in other words, the mounting slide inserts 13 are very much more robust than the standard slide inserts 3. The materials, which come to question, of the mounting and slide zones should also be harder than the slide surfaces of the guide rails 11. The hardness of usual guide rails lies in the region of HB (Brinel hardness)=130 to 175. The hardness of the material of the mounting slide zone is at least HB=160, wherein a material of that kind, for example in the case of use of GGG50, has a hardness HB of 160 to 240. In the mean, the material used is thus harder than the guide rail.

The material of the mounting slide insert 13 shall be, above all, insensitive to impact, wear resistant to the largest extent and, if possible, also self-lubricating.

Cast iron with nodular graphite, for example GGG50 or GGG60, has proved particularly satisfactory for production of the mounting slide inserts 13, since the mechanical properties, particularly the impact resistance and hardness as well as the self-lubricating properties of this material are very suitable. This material is especially advantageous. In addition, it can be readily processed industrially.

Presently preferred forms of embodiment consist of a U-shaped intrinsically stable element. Stated in other words, in this case the mounting slide insert 13 is a robust and stiff element which is dimensioned in correspondence with the loads. An integral (i.e. produced from a unitary material) element made of metal in which the mounting slide zones are integral components of the mounting slide insert 13 is preferred.

However, forms of embodiment are also conceivable in which the mounting slide zones are specially coated. TiN or a ceramic coating can, for example, be used as coating.

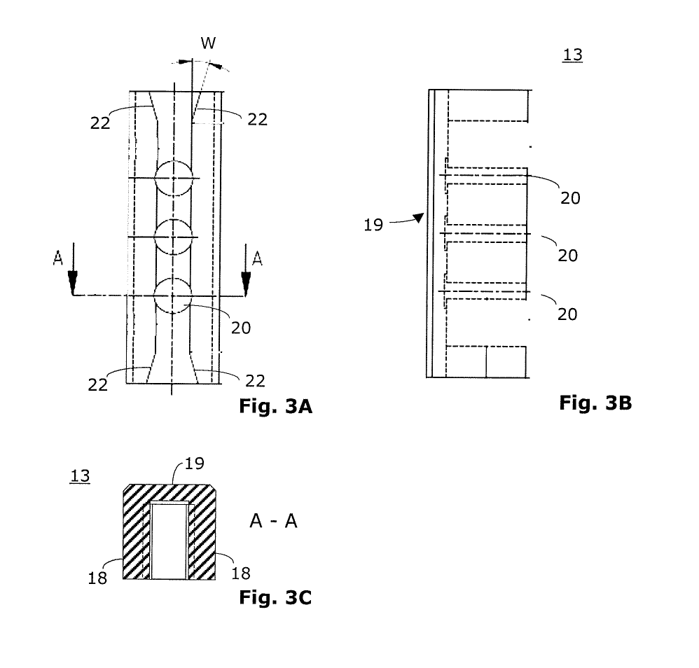

Details of a further mounting slide insert 13 according to the present invention are shown in FIGS. 3A to 3C. The illustrated mounting slide insert 13 is similar to that shown in FIG. 2B and can also be fastened in similar mode and manner. FIG. 3A is a plan view, FIG. 3B a side view and FIG. 3C a sectional view along the line A-A. In these illustrations it can be seen that this form of embodiment also has a substantially U-shaped form. The two lateral limbs 18 of the “U” are connected together by a center web 19. In this form of embodiment three horizontal bores or horizontal milled recesses 20 are also provided in the region of the mounting slide zones. Chamfers 22, which have an angle “W”, are provided at the inlet side and outlet side.

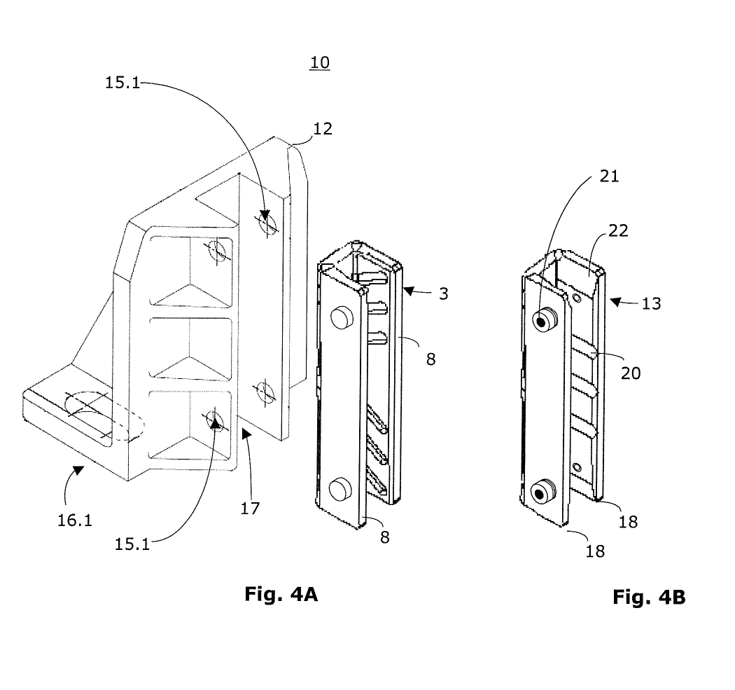

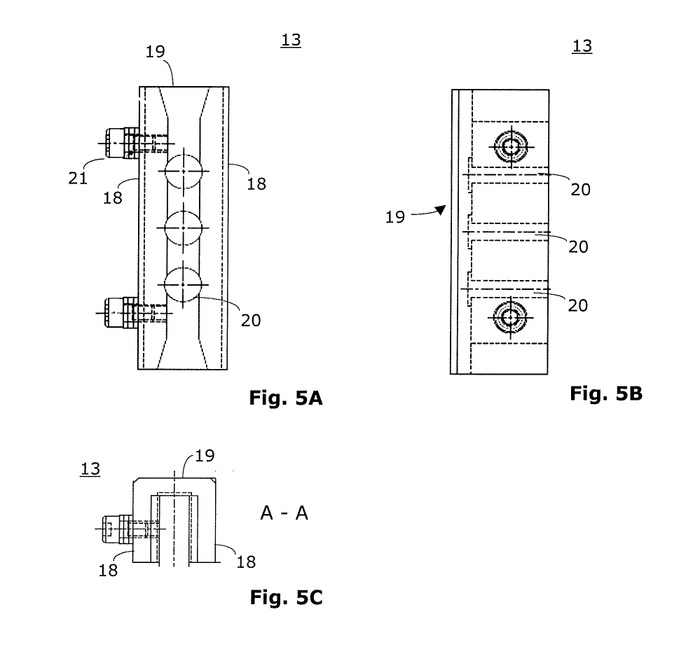

Another form of embodiment can be inferred from FIGS. 4A, 4B and 5A to 5C. This form of embodiment is in turn similar to the other forms of embodiment, but on this occasion other fastening means are used, which are characterized in the figures by the reference numeral 21. These can be, for example, screws which can be screwed from the side into one of the lateral limbs 18 of the mounting slide insert 13. In this case holes 15.1 are provided laterally at the corresponding guide shoe 12. After pushing of such a mounting slide insert 13 into the longitudinal groove 17 of a corresponding guide shoe 12 the mounting slide insert 13 can be secured against slipping out by insertion and tightening of the screws 21. The insert is thus fixed in the guide shoe 12. The mounting slide insert 13 can obviously also be directly firmly screwed with use of corresponding holes 15.1 in the guide shoe 12. A similar fastening can, but does not have to, be provided for the standard slide inserts 3. In the example of embodiment according to FIG. 4A a known standard slide insert 3 with retaining dogs is used, wherein the retaining dogs detent in the holes 15.1 of the guide shoe 12. The illustrated standard slide insert 3 with retaining dogs is made of plastics material and correspondingly resilient so that the detenting can be carried out. The guide shoe 12 illustrated in FIG. 4A is provided with a base surface 16.1 so as to be able to be installed at an elevator car below or above.

It may be noted as follows with regard to the detachable fastening of the various mounting and standard slide inserts 13 and 3. In the case of the mounting slide inserts 13 quite different forces arise, since these linings 13 do indeed have to be intentionally designed for the purpose of interacting with the guide rail 11 so as to develop a cleaning action, i.e. the fastening of the mounting slide inserts 13 should preferably be designed to be stronger or more robust than that of the standard slide inserts 3.

Preference is given to those forms of embodiment of the sliding guide device 10 in which the guide shoe 12 does not have to be demounted in order to mount or demount the slide insert 3 or 13. This has the advantage that re-adjustment of the guide shoe 12 at the elevator car 14 is not required, since the guide shoe 12 is left in its set position and merely the slide inserts 3, 13 are changed.

However, instead of the illustrated fastening means 15 or 21 use can also be made of latch-like fastening means or groove-and-key connections.

Sliding guide devices 10 in which the mounting slide inserts 13 are fastenable to the guide shoe 12 by means of force-locking connections and the standard slide inserts 3 by means of shape-locking connections are particularly suitable.

The details described further above with respect to material and other characteristic features of the forms of embodiment can be transferred to any of the described forms of embodiment.

In order to be able to use the present invention in practice, so-termed mounting sets are supplied together with the delivery of the components of a elevator installation, which sets comprise the required number of guide shoes 12, standard slide inserts 3 and mounting slide inserts 13. Moreover, the necessary fastening means 15/21 for the alternative fastening of the standard slide inserts 3 or of the mounting slide inserts 13 are provided, wherein the standard slide insert 3 and the mounting slide insert 13 are detachably fastenable in the housing of the guide shoe 12 by the fastening means 15/21.

Such a mounting set can be used in the construction of a new elevator installation or in a general overhaul or modernization. In that case the following method is preferably used for placing an elevator installation in operation. In a first step the guide shoe housing 12 is fastened to the elevator car 14 in order to then insert the mounting slide inserts 13 into the guide shoe housing 12 and to fasten them there with use of fastening means 15/21. As described further above, the mounting slide inserts 13 can also be initially inserted in the guide shoe housing 12 before these are then fastened as a subassembly to the elevator car 14.

The sliding guide devices 10 together with the mounting slide inserts 13 are then used during the construction or revision phase for vertical guidance of the elevator car 14 along the guide rails 11. Before finally placing in operation, or in conjunction with conclusion of the construction or revision phase, the fastening means 15/21 are then loosened and the mounting slide inserts 13 removed from the guide shoe housing 12. The standard slide inserts 3 are then installed in the guide shoe housings 12, wherein the sliding guide devices 10 with standard slide inserts 3 are used during the subsequent normal operation for vertical guidance of the elevator car 14 along the guide rails 11.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A mounting set for mounting a sliding guide device at an elevator car of an elevator installation, wherein the mounting set comprises:
at least one guide shoe;
at least one standard slide insert with a standard slide zone;
at least one mounting slide insert with mounting slide zone; and
wherein said mounting slide zone of said mounting slide insert is formed of a first material different from a second material forming said standard slide zone of said standard slide insert.

2. The mounting set according to claim 1 wherein said first material of said mounting slide zone of said mounting slide insert during movement of the elevator car along a guide rail of the elevator installation performs a cleaning action at the guide rail.

3. The mounting set according to claim wherein said mounting slide zone of said mounting slide insert has structural surface features for performing the cleaning action.

4. The mounting set according to claim 1 wherein said second material is a plastics material and said first material is a metal material, wherein said first material has a greater hardness than a third material forming a guide rail of the elevator installation.

5. The mounting set according to claim 1 including fastening means for detachably fastening said mounting slide insert to said guide shoe and for detachably fastening said standard slide insert to said guide shoe.

6. A mounting slide insert for use in a guide shoe at an elevator car of an elevator installation with guide rails, wherein the mounting slide insert has a slide zone and fastening regions so as to be able to insert the mounting slide insert into the guide shoe and fasten it there, comprising: the mounting slide insert being a slide insert for use prior to final placing of the elevator installation in operation or in conjunction with the conclusion of a construction or revision phase and the mounting slide insert having two mounting slide zones which extend substantially parallel to one another and are formed of a metal material, wherein said metal material is harder than a material forming the guide rail, whereby during movement of the elevator car along the guide rail of the elevator installation the mounting slide insert performs a cleaning action at the guide rail.

7. The mounting slide insert according to claim 6 wherein the mounting slide insert is a U-shaped, intrinsically stable element and is formed as an integral element made of said metal material in which said mounting slide zones are integral components of the mounting slide insert.

8. The mounting slide insert according to claim 6 wherein said metal material of said mounting slide zones has a minimal hardness corresponding with a Brinel hardness HB of 160.

9. The mounting slide insert according to claim 6 wherein said mounting slide zones have structural surface features formed as grooves or depressions.

10. The mounting slide insert according to claim 6 wherein the mounting slide insert is shaped to be fastened in a force-locking manner to the guide shoe.

11. An elevator installation having an elevator car with a guide shoe mounted thereon and with a mounting slide insert according claim 6 detachably fastened to the guide shoe.

12. A method of placing into operation an elevator installation with an elevator car and a sliding guide device for guidance of the elevator car along a guide rail, comprising the steps of:
a. fastening a guide shoe to the elevator car;
b. inserting a mounting slide insert with mounting slide zone into the guide shoe;
c. fastening the mounting slide insert to the guide shoe with fastening means, and using the guide shoe with the mounting slide unit during a construction or revision phase of the elevator installation for vertical guidance of the elevator car along the guide rail (11);
d. prior to final placing the elevator installation in operation or in conjunction with a conclusion of the construction or revision phase, loosening the fastening means;
e. removing the mounting slide insert from the guide shoe; and
f. mounting a standard slide insert with a standard slide zone to the guide shoe, and using the guide shoe with the standard slide insert during subsequent normal operation of the elevator installation for vertical guidance of the elevator car along the guide rail.
